(19) United States
(12) Patent Application Publication
(10) Pub. No.: US 2026/0255457 A1
(43) Pub. Date: Aug. 27, 2026

(54) CURRENT SINK WITH PARALLEL LOAD FOR AN LED CHAIN

(71) Applicant: Diehl Aerospace GmbH, Ueberlingen (DE)

(72) Inventors: Uwe NIEBERLEIN, Roth (DE); Gunther KONINGER, Neuhof (DE)

(73) Assignee: Diehl Aerospace GmbH, Ueberlingen (DE)

(21) Appl. No.: 19/545,701

(22) Filed: Feb. 20, 2026

(30) Foreign Application Priority Data
Feb. 24, 2025 (DE) 102025106825.9

(51) Int. Cl. H05B 45/46; B64D 47/02; H05B 45/325

(52) U.S. Cl. CPC H05B 45/46; B64D 47/02; H05B 45/325; B64D 2203/00; B64D 2221/00

(57) ABSTRACT

A current sink (22) contains two supply poles (28a,b) for a continuous DC voltage (UG) and a current path (30) connecting said supply poles that, during operation (B), carries a total current (IG), the following being connected in series in the current path (30): a connection (32) for the LED chain (20) and a controllable resistor element (42) comprising a parallel circuit comprising load paths (46a-d), each of which comprises a series connection comprising a load resistor (44a-d) and a switch (40a-d), and a control unit (60) in order to take the measurement voltage (UM) as a basis for controlling the switches (40a-d) in such a way that a predeterminable total current (IG) and a predeterminable element voltage (UE) across the resistor element (42) are obtained in the current path (30).

A light source (6) for a light device (4) of an aircraft (2) contains the current sink (22) and the LED chain (20) connected to the connection (32).

A light device (4) for an aircraft (2) contains at least one light source (6a-c).

### BACKGROUND OF THE INVENTION

The present invention relates to a current sink for an LED chain, i.e. a series connection comprising multiple LEDs (light-emitting diode). Such a current sink is used to set a desired current through the LED chain and thus the LEDs, the voltage dropped across the LED chain for the same current being able to vary greatly from one LED chain to another, e.g. for production reasons.

### DISCUSSION OF THE PRIOR ART

DE 10 2012 107 882 A1 discloses a circuit for controlling a multiplicity of LEDs connected in series (LED chain). According to one example, the circuit comprises a switch-mode converter that can be operated as a current source and that is connected to the multiplicity of LEDs in order to supply them with a constant load current. The switch-mode converter comprises an inductor connected in series with the multiplicity of LEDs in such a way that the same load current flows through the inductor and the multiplicity of LEDs. No capacitor is coupled between the inductor and the multiplicity of LEDs. A potential-free driver circuit is connected in parallel with each individual LED (from the multiplicity of LEDs). The potential-free driver circuit is designed to control the intensity of the light imitated by the respective LED according to an associated modulated input signal by accepting all or at least part of the load current of said LED, thereby forming a bypass to the respective LED.

### SUMMARY OF THE INVENTION

The present invention is directed to improvements with regard to a current sink for an LED chain.

More specifically, the present invention is directed to a current sink for an LED chain having an upper and a lower supply pole that are fed from a continuous DC voltage during operation as intended and having a single current path connecting the two supply poles that, during operation, carries a total current, with the following being connected in series in the current path: a two-pole connection for the LED chain, and a controllable resistor element containing a parallel circuit comprising at least two load paths, each of the load paths containing a series connection comprising a load resistor and a switch for opening or closing the respective load path, and having a measuring resistor that maps the total current currently flowing through the current path to a present measurement voltage, and having a control unit that is connected to all the switches and configured to take the measurement voltage as a basis for controlling the switches such that a predeterminable total current and a predeterminable element voltage dropped across the resistor element are obtained in the current path.

The current sink according to the present invention is a current sink for an LED chain. Such an LED chain is a two-pole network and contains a series connection comprising multiple LEDs in a single branch. During operation, the LED chain carries a total current. The same total current thus flows through the branch and each of the LEDs. A given total current results in-depending on the individual entity of the LED chain-a voltage that is dropped across the entire chain. This voltage can vary greatly from one instance to another of such-including identical-chains, e.g. between 20V and 35V.

The current sink contains an upper and a lower supply pole. During operation of the current sink as intended (with an LED chain connected), the supply poles are fed from a continuous DC voltage. “Continuous DC voltage” means that even a PWM (Pulse Width Modulation) mode of the LED chain involves an (in particular constant) DC voltage being continuously applied, i.e. the continuous DC voltage is not switched in line with a PWM.

The current sink contains a single current path. The current path connects the two supply poles. During operation, the current path carries the total current mentioned above. The total current can assume different values and can even be zero, i.e. is in particular variable over time, and is, as intended, caused by the continuous DC voltage applied to the current sink with the connected LED chain. The total current may also be switched in a PWM cycle (see below).

The current path contains the following elements connected in series, all of which are components of the current sink:
a two-pole connection for the led chain,
a controllable resistor element.

These are explained in more detail below. The two elements in the series connection (and the LED chain, see below) thus always currently carry the same total current during operation.

Optionally (see below), a shunt resistor is also present as a third element of the series connection. The two-pole connection can be used to connect a or the LED chain to the current sink. To this end, the LED chain is included in the series connection, or becomes part of the series connection. In other words, the series connection between the two supply poles is broken at the point of the connection and the LED chain can be or is inserted there. The LED chain is thus part of the current path and carries the same total current.

Although the invention is directed to an LED chain here, the current sink can also be used to operate other electrical loads. In other words, any load in the form of a two-pole network intended to carry a current using a current sink can be connected to the connection.

The controllable resistor element contains or is a parallel connection comprising at least two or more, in particular four, load paths. Each of the load paths in turn contains a series connection comprising a respective load resistor and a switch. During operation, the parallel connection carries the total current. Each of the load paths (when its switch is closed) carries a respective load current. All the load currents of all the load paths add up to produce the total current (if at least one of the load paths allows current to pass by means of a closed switch).

The respective switch is used or is configured to open or close the respective load path. In other words, opening the switch can be used to interrupt the load path so that there is then no flow of current through the load path. “No flow of current” should be understood to mean that an insignificant reverse current can still flow, e.g. if the switch is an electronic switch. When the switch is closed, the load path is also connected so that the load current can or does flow through the load path. In particular, there is then no or only a negligible voltage drop across the switch. The flow of current in the load path results in the relevant load resistor being “activated” in the current sink.

Closing different combinations of the switches allows various total resistances to be achieved on the resistor element as the interconnection of the respective load resistors. It is thus possible to adjust the total resistance and thereby control the voltage dropped across the resistor element in the series connection. In particular, the voltage ratios in the series connection can thus be adapted for the current/voltage requirements of the LED chain. This can be done in particular independently of the desired total current.

The elements of the current sink connected in series are thus listed in full.

The current sink also contains a measuring resistor (as a separate or third element of the series connection or as part of the resistor element, see below). The measuring resistor maps the current currently flowing through the current path, i.e. the total current, to a present measurement voltage. By evaluating the present measurement voltage, it is thus possible to determine the present total current.

The current sink additionally contains a control unit (i.e. which is not part of the series connection). Said control unit is connected to all the switches and configured to take the measurement voltage as a basis for controlling the switches such that-when at least one switch is closed-a predeterminable total current and a predeterminable element voltage dropped across the resistor element are obtained in the current path. The following is thus possible: A given continuous DC voltage or a given voltage applied to the supply poles can result in the load currents and thus the element voltage dropped across the resistor element being kept at a desired level, but the total current being varied by passing the current via a measuring resistor of varying magnitude.

One consideration here is that, in particular in the case of an LED chain, the voltage drop across the latter for a total current of the same magnitude can vary greatly from one instance to another. For this reason, the element voltage dropped across the resistor element in the series connection needs to be adjusted given the same magnitude of the continuous DC voltage. This can be done only by adjusting the total resistance of the resistor element. The total current can then be set to a desired value by controlling the switches.

The invention results in simplified resistor LED control for operation in LED light devices with switches.

LED control is provided that can be used to switch LEDs quickly despite a simple design and that is no longer reliant/dependent on the character properties of control diodes and transistors used in circuits customary in the art.

In a preferred embodiment, the magnitudes of the load resistors for the load paths are selected according to a binary sequence in relation to each other. Given a number of N load paths, the magnitude of the load resistor in a first load path is thus R0. In the second load path, the magnitude of the load resistor is ½R0, in the third load path it is ¼R0, in the fourth load path it is ⅛R0, etc. As such, closing the switches in the style of binary codes allows a corresponding number of total resistance values/total resistances to be produced in the resistor element.

In other embodiments, the load resistors (the values thereof) of different load paths may also be otherwise scaled and/or identical.

In a preferred embodiment, the measuring resistor is a shunt resistor that is an additional (third) element of the series connection of the current sink. The shunt resistor then carries the total current (which can also become zero) at any time by way of the current path. This means that it is particularly easy to measure the voltage or current to determine the total current.

In a preferred variant of this embodiment, the shunt resistor is arranged at the lower supply pole as the first element. In other words, the shunt resistor is the element that is arranged closest to the lower supply pole in the current path. In particular if the lower supply pole is an earth pole, the shunt resistor thus has its one pole connected to earth and can thus be produced particularly easily and cost-effectively.

In an alternative preferred embodiment, the measuring resistor is formed by one component measuring resistor per load path. Each of the component measuring resistors is at least a portion of the respective load resistor or is identical to the load resistor. Thus, no additional element is required in order to form the measuring resistor.

In a preferred embodiment, the switch within at least one of the load paths is arranged nearest the lower supply pole as the first element of the series connection (within the resistor element). In other words, the switch is the element of the series connection that is arranged closest to the lower supply pole in the load path. In particular if the lower supply pole is an earth pole and a separate measuring resistor is not present, the switch thus has its one pole connected to earth and can thus be produced particularly easily and cost-effectively.

In a preferred embodiment, the connection for the LED chain is arranged in the current path at the upper supply pole as the first element of the series connection. In other words, the connection, and thus e.g. an LED chain as a load, is the element of the series connection that is arranged closest to the upper supply pole in the current path. If the upper supply pole has a higher electrical potential (in particular positive operating potential) applied to it than the lower supply pole (in particular earth), only the load, e.g. the LED chain, is exposed to the highest potential. All other elements of the series connection are exposed to lower potentials or earth. The elements of the current sink are thus protected.

In a preferred embodiment, each of the switches is a PWM switch for a PWM mode of the LED chain. In other words, there is provision in this embodiment for the LED chain to be controlled in a PWM mode, the PWM mode being provided in particular exclusively via the PWM switches, specifically when the continuous DC voltage (not switched by means of PWM) is applied between the supply poles as intended. This avoids subjecting the entire current sink to a changing supply voltage. The current sink can actually (in line with PWM continuously) be supplied with the continuous DC voltage, which simplifies control of the current sink or the current sink with the connected LED chain.

The present invention is also achieved by a light source. The light source is a light source for a light device of an aircraft. The light source contains the current sink according to the invention. The light source also contains the LED chain mentioned above. The LED chain contains a plurality of LEDs connected in series. The LED chain is connected in the light source between the two connecting poles of the two-pole connection. In other words, the LED chain in the light source forms another element of the series connection in the current path. During operation, both the LED chain and each of the LEDs therefore carry the total current that flows through the current sink or the current path thereof.

The light source and at least some of the possible embodiments thereof and the respective advantages have already been explained analogously in connection with the current sink according to the invention. In particular, this means that the preferred embodiments mentioned above in connection with the current sink also form preferred embodiments of the light source.

The present invention is also directed to a light device of an aircraft or for an aircraft as already explained above. The light device contains at least one of the light sources according to the invention.

The light device and at least some of the possible embodiments thereof and the respective advantages have already been explained analogously in connection with the current sink and light source according to the invention. In particular, this means that the preferred embodiments mentioned above in connection with the current sink and light source also form preferred embodiments of the light device.

In particular, the light device contains multiple light sources according to the invention. For example, a multi-colour light device can thus be realized, which contains as the first light source a light source having a white LED chain (LEDs generate white light), a second light source having red LEDs, a third light source having green LEDs and a fourth light source having blue LEDs.

In particular, the light device contains at least two of the light sources according to the invention. In particular, the light device also contains an overall controller for the light device. The control unit of at least one of the light sources according to the invention, in particular of multiple or all of the light sources according to the invention, can then be in the form of at least part of the overall controller. In other words, a single overall controller can undertake control of at least one, in particular multiple or all, of the control units of the light sources according to the invention, which simplifies the overall arrangement.

The light device can contain a PWM element. This is used or is configured to control at least one, in particular multiple or all, of the light sources according to the invention using a respective PWM signal. The PWM element is connected to the switches of the respective light source for this purpose, which is why the respective light source then has the embodiment explained above that the switches thereof are PWM switches. The PWM element is configured to control the respective switches using the respective PWM signal. This means that at least one, in particular multiple or all, of the light sources according to the invention in the light device can be controlled particularly easily by a central PWM element. In particular, the PWM element is also in the form of at least part of the overall controller of the light device.

In a preferred embodiment, the light device contains a supply module. The supply module is used or is configured to supply the supply poles of at least one, in particular multiple, in particular all, of the light sources according to the invention with a respective continuous DC voltage. This means that the light sources can be supplied with energy particularly easily.

In a preferred variant of this embodiment, the supply module is configured to select or change the magnitude of the respective continuous DC voltage for a respective light source according to the invention on the basis of the magnitude of the voltage dropped across the resistor element in the respective light source. In particular, it is thus possible to lower the continuous DC voltage to a minimum necessary level, so that the smallest possible or no voltage is dropped across the resistor element. This reduces the power consumption and heat generation of the respective light source or current sink.

The present invention is further directed to a method configured to produce the light source according to the invention. The method involves the LED chain being provided. Subsequently, at least one of the load resistors is selected according to an electrical property of the LED chain. The current sink is then provided comprising this/these load resistors. The provided LED chain is then connected to the connection of the provided current sink. In other words, the load resistors in a particular individual entity of the light source are selected according to the properties of the individual LED chain currently used there, or the load resistors are individually tailored to the individually used LED chain. This results in a light source that has particularly favourable electrical properties as an overall system, e.g. energy consumption/heat generation each reduced to a possible minimum, etc.

In a preferred embodiment, a selection of at least two sets of load resistors is provided. Each of the sets is at least a portion of the load resistors of at least one of the current sinks. At least one of the load resistors is selected in the method described above by selecting one of the sets for the current sink and fitting the current sink with this set of the load resistors. The load resistors of the set are thus used/installed as load resistors in the current sink. This means that the current sinks can be easily adapted for the respective LED chain at least to a certain extent.

The invention is based on the following findings, observations or considerations and has furthermore the following preferred embodiments. These embodiments are also sometimes referred to as “the invention” for the sake of simplicity. The embodiments may in this case also contain parts or combinations of the embodiments mentioned above or correspond to them and/or possibly also include embodiments which have not yet been mentioned.

The invention results in simplified resistor LED control for operation in LED light devices with switches. LED control is described that can be used to switch LEDs quickly despite a simple design and that is no longer reliant/dependent on the character properties of control diodes and transistors.

The invention results in the RC costs (recurring costs for each device) of the current sinks being reduced. These become cheaper and faster.

The invention is based on the notion that previous current sinks were produced in hardware with many expensive components (e.g. control diodes). The hardware (control diode) is controlled according to the invention by control/software (control unit based on voltage/current measurement using the measuring resistor).

The invention is based on the following finding: In order to be able to switch the LEDs of an LED chain quickly at all operating points and to be able to ensure a constant current in the LEDs over temperature and all tolerances, a current source with transistors connected in parallel that are controlled is set up in practice. This is complex and costs a lot of money, components, current centring, vibration suppression, control loop.

This invention therefore describes LED control that can be used to switch LEDs quickly despite a simple design and that is no longer reliant/dependent on the character properties of control diodes and transistors.

Fundamental advantages are:
lower costs
market protection
approximately 40 units per 42-inch device with 4-inch control.

Basic ideas of the invention are also:
optionally an adjustable voltage source (supply module, continuous DC voltage) to increase efficiency,
selection of the load resistors on the basis of the forward voltage of the LEDs, binning (sorting of the LEDs) and LED light output and the necessary gradations of the total current in order to be able to implement desired brightness levels when the LEDs are operating
dual function of the load resistors as load/current brake for the total current on the one hand and shunt resistor/measuring resistor on the other
voltage measurement across the load resistors in function as shunt resistors supplies the current when the LEDs are switched on (at least one of the switches closed) and provides direct information for voltage adjustment of the continuous DC voltage in the supply module
switch as “low-R switch”
switch for supplying the LED PWM.

One concept of the invention is the following:

LEDs are operated with a series resistor (resistor element). The series resistor(s) are selected according to the forward voltage and brightness binnings of the LEDs. The forward voltages of the LEDs can vary to a very great extent, sometimes up to 1 V. By contrast, the thermal response of the LEDs is approximately 0.1 V per LED in the range between −15° C. and 85° C. With a low-resistance low-cost switch, e.g. a MOSFET, which can be very small and inexpensive, e.g. 5 ct, as it does not have to dissipate any power loss, the LED is switched (by the switches) in the style of a PWM. In the ON state (at least one switch closed), a voltage corresponding to the present current (total current) can be measured across the resistors (load resistor), which are both a current limiting resistor and a current shunt (measuring resistor). The control unit can now correct the light by tracking the LED PWM cycle. If more than one switch is installed (at least two load paths), the current can be kept almost constant by switching different combinations (of the switches) and skilfully selecting the (load) resistors. Depending on the maintained voltage drop across the resistors, e.g. 2.5 V, a change of current in the LEDs by a factor of 1.5 is assumed over the temperature range. If the load resistors are selected in such a way that e.g. the currents each differ by a factor of ½ (binary sequence, see above), then with four available switching stages (load paths) the current variations can probably be adjusted to approximately 10%.

At the same time, the voltage across the (load) resistors can be used to directly measure by how much the LED supply voltage (continuous DC voltage) is too high or too low compared to the LED chain.

In addition, the control unit can optionally send a correction to the LED voltage source (of the continuous DC voltage) in order to compensate for the coarse thermal response of the (light) device. On the one hand, the thermal drift can already be largely compensated for and at the same time the efficiency of the device can be optimized.

Since the LEDs are switched directly using fast switches, very fast current adjustment is achieved by the LEDs. The settling time is now determined only by the switch. This means that extremely fast switching times are now possible, which can surpass those previously known from practice.

The main power loss occurs in cheap (load) resistors, which can easily be routed in series (at least one of the load resistors can be a series and/or parallel connection of individual resistors).

### BRIEF DESCRIPTION OF THE DRAWINGS

Further features, effects and advantages of the invention are obtained from the description of a preferred exemplary embodiment of the invention that follows and the accompanying figures, in which, in each case in a basic schematic diagram:

FIG. 1 shows an aircraft with a light device, containing a light source comprising an LED chain and a current sink,

FIG. 2 shows an alternative light device with three light sources.

### DETAILED DESCRIPTION OF THE INVENTION

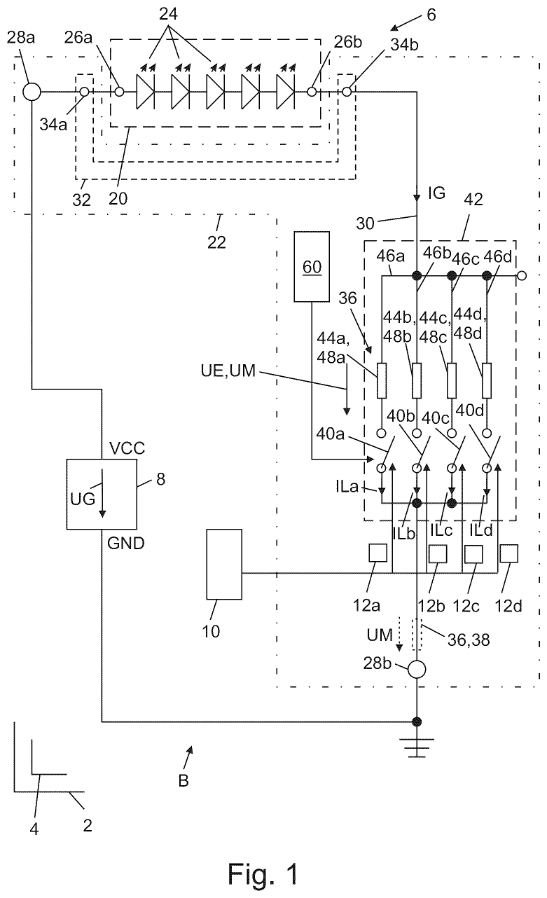

FIG. 1 shows a detail from an aircraft 2, which is not shown in greater detail. The aircraft 2 contains a light device 4 for the aircraft 2. The light device 4 contains a light source 6 and also an energy source 8 and a PWM control device 10.

FIG. 1 shows the light device 4 during operation B as intended. The energy source 8 therein generates a continuous DC voltage UG between an earth potential GND and a positive operating potential VCC. The PWM control device 10 generates a PWM signal 12.

The light source 6 contains an LED chain 20 and also a current sink 22 for the LED chain 20 or operation B thereof. The LED chain 20 here is a series connection comprising a plurality of LEDs 24, only five of which are shown as an example in FIG. 1 for the sake of clarity. The LED chain 20 therefore has two electrical contacts 26a, b.

The current sink 22 for the LED chain 20 contains an upper supply pole 28a and a lower supply pole 28b. During operation B, the two supply poles 28a,b are fed from the continuous DC voltage UG, that is to say the energy source 8 is connected to the two supply poles 28a,b.

The current sink 22 contains a current path 30 that connects the two supply poles 28a,b to one another. During operation B, the current path 30 carries a total current IG that is caused by the continuous DC voltage UG and varies over time. The total current IG can also become zero if all the switches 40a-d are open, see below.

The following components are connected in series in the current path 30:

The upper supply pole 28a is followed by a two-pole connection 32 of the current sink 22 having two connecting poles 34a,b. The LED chain 20 has its contacts 26a,b connected to the latter. The LED chain thus also forms an element of the series connection in the current path 30.

The current sink 22 or the series connection thereof also contains a controllable resistor element 42. This consists of a parallel connection comprising four load paths 46a-d. Each of the load paths contains a series connection comprising a respective load resistor 44a-d with a respective switch 40a-d.

The load resistors 44a-d here are scaled in the style of a binary sequence. The following holds for the magnitudes thereof: load resistor 44a has the value R0, 44b has the value R0/2, 44c has the value R0/4 and 44d has the value R0/8.

During operation B, the entire resistor element 42 carries the total current IG. A load current ILa-d flows in each of the load paths 46a-d. All the load currents ILa-d add up to the total current IG at any time. The magnitude of the resistance of the resistor element 42 can be changed by selectively controlling (opening or closing) the switches 40a-d. In other words: depending on the control of the switches 40a-d, the magnitude of the element voltage UE dropped across the resistor element 42 can be altered for a given total current IG-assuming appropriate voltage/current ratios.

The load resistors 44a-d also serve as a measuring resistor 36 here. This is achieved by each of the load resistors 44a-d acting as a component measuring resistor 48a-d. The measuring resistor 36 maps the total current IG currently flowing through it and thus the current path 30 to the present measurement voltage UM, which is then identical to the element voltage UE in this case. This means that the measurement voltage UM and, based thereon, therefore also the total current IG currently flowing in the current path 30 are known. This is because it is known which of the switches 40a-d is closed at any time, which is why the load resistor 44a-d of the relevant load path 46a-d adds to the measuring resistor 36.

In an alternative variant, indicated by dashed lines here, the measuring resistor 36 is in the form of a shunt resistor 38 as an additional element of the series connection. In this case, the measurement voltage UM correlated with the total current IG is dropped across said shunt resistor. The shunt resistor 38 is arranged in the current path 30 at the lower supply pole 28b as the first element.

The switches 40a-d are thus used to open, i.e. interrupt, or close the load path 46a-d and thus also the current path 30. When all the switches 40a-d are in the open state, the flow of current is interrupted, i.e. the total current IG is zero. When they are in the closed state, the load current ILa-d flows through the switch 40a-d without (significant) voltage being dropped across said switch.

The current sink 22 additionally contains a control unit 60. This is configured to take the measurement voltage UM as a basis for controlling the switches 40a-d such that, when the switch 40 is closed, a predeterminable total current IG and also the desired element voltage UE are obtained in the current path 30.

The switch 40 in the respective load path 46a-d is nearest the lower supply pole 28b as the first element of the series connection. The connection 32, on the other hand, is arranged in the current path 30 at the upper supply pole 28a as the first element of the series connection.

The switches 40a-d here are also PWM switches for a PWM mode of the LED chain 20. The reason is that, during operation B, the switches 40a-d are controlled by the PWM control device 10 using PWM signals 12a-d, in order to open and close the entire current path 30 according to pulse width modulation and therefore permit or interrupt the flow of current of the total current IG and thus switch the LED chain 20, or the LEDs 24 thereof, on and off according to a PWM.

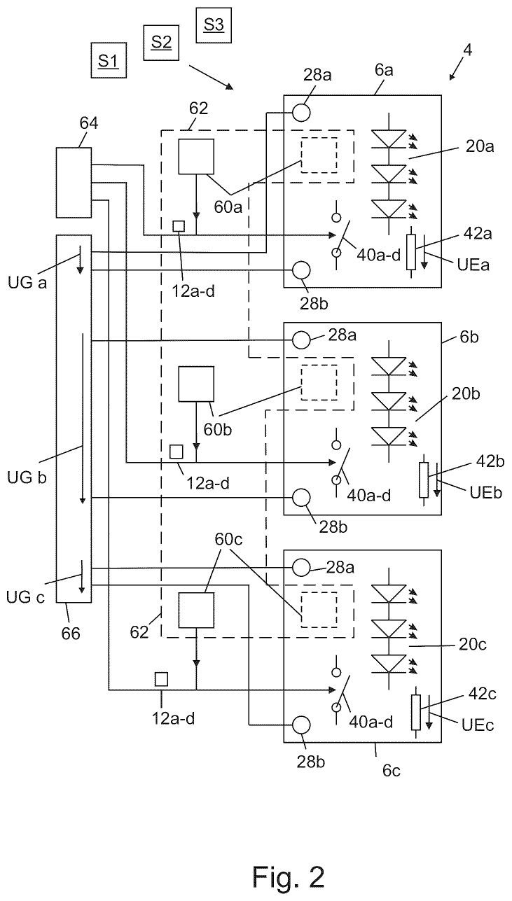

FIG. 2 shows an alternative light device 4 with a total of three light sources 6a-c, all of which are designed according to FIG. 1. However, the respective LED chains 20a-c emit light of different colours during operation. For example, the LED chain 20a is fitted with red-emitting, the LED chain 20b with green-emitting and the LED chain 20c with blue-emitting LEDs 24.

The light device 4 here contains an overall controller 62 of the entire light device 4, which is jointly responsible for controlling all three light sources 6a-c. The respective control units 60a-c of the respective current sinks 22a-c are in the form of parts of the overall controller 62. In other words, the individual light sources 6 do not contain their own dedicated control units 60, but rather these disaggregate to produce corresponding control terminals or control connections or signal paths for the overall controller 62 and partial control functions implemented therein for the respective light source 6a-c. Similarly, the light device 4 contains a central PWM element 64 that undertakes the task of the respective PWM control devices 10 in the light sources 6a-c.

The PWM element 64 provides-as explained analogously above-overall control of all the light sources 6a-c or the respective switches 40a-d thereof.

The light device 4 also contains a supply module 66 that, as already explained, also analogously replaces respective individual energy sources 8 for the light sources 6a-c and collectively produces all of the continuous DC voltages UGa-c of the light sources 6a-c or current sinks 22a-c.

The supply module 66 is also configured to select or change the magnitude of the continuous DC voltage UGa-c for the respective light source 6a-c on the basis of the magnitude of the measurement voltage UM in the respective light source 6a-c. In particular, the continuous DC voltage UGa-c is lowered in each case to the extent that the element voltage UE becomes as low as possible or zero for the desired total current IGa-c in order to reduce the power loss in the respective light source 6a-c or current sink 22a-c to a minimum.

Producing the light sources 6a-c involves the respective LED chain 20a-c being provided. The load resistors 44a-d are then selected according to an electrical property of the LED chain 20a-c, here the respective sum of the forward voltages of the LEDs 24. The respective current sink 22a-c is individually provided comprising these load resistors 44a-d. The provided LED chain 20a-c is connected to the connection 32a-c of the provided current sink 6a-c. This means that the load resistors 44a-d (the magnitudes thereof) are individually adapted for the respective LED chain 20a-c. There can therefore be provision for different values of load resistors 44a-d in each current sink 22a-c.

In this scenario, a selection of three sets S1-3 of load resistors 44a-d is provided, which differ in their resistance values from set S1 to set S2 and set S3. These sets are assigned to different voltage/binning types of LED chains 20. Each of the sets S1-3 contains all the load resistors 44a-d for a respective current sink 22a-c. The load resistors 44a-d of a specific current source 22a-c are then selected by selecting one of the sets S1-3 for the respective individual current sink 22a-c and fitting the current sink 22a-c with this set. The selection is made by selecting the set S1-3 that best matches the LED chain 20 currently provided for the current sink 22a-c.

### LIST OF REFERENCE SIGNS

2 aircraft
4 light device
6 light source
8 energy source
10 PWM control device
12a-d PWM signal
20 LED chain
22 current sink
24 LED
26a,b contact (LED chain)
28a,b upper, lower supply pole
30 current path
32 connection
34a,b connecting poles (connection)
36 measuring resistor
38 shunt resistor
40a-d switch
42 resistor element
44a-d load resistor
46a-d load path
48a-d component measuring resistor
60 control unit
62 overall controller
64 PWM element
66 supply module
B operation
UG continuous DC voltage
GND earth potential
VCC operating potential
IG total current
UM measurement voltage
UE element voltage
ILa-d load current
S1-3 set

What is claimed is:

1. A current sink for an LED chain (20),
having an upper and a lower supply pole that are fed from a continuous DC voltage (UG) during operation (B) as intended,
having a single current path connecting the two supply poles that, during operation (B), carries a total current (IG),
the following being connected in series in the current path:
a two-pole connection for the LED chain, and
a controllable resistor element containing a parallel circuit comprising at least two load paths, each of the load paths containing a series connection comprising a load resistor and a switch for opening or closing the respective load path,
and having a measuring resistor that maps the total current (IG) currently flowing through the current path to a present measurement voltage (UM),
having a control unit that is connected to all the switches and configured to take the measurement voltage (UM) as a basis for controlling the switches such that a predeterminable total current (IG) and a predeterminable element voltage (UE) dropped across the resistor element are obtained in the current path.

2. The current sink according to claim 1, wherein the magnitudes of the load resistors for the load paths are selected according to a binary sequence in relation to each other.

3. The current sink according to claim 1, wherein the measuring resistor is a shunt resistor that is an additional element of the series connection of the current sink.

4. The current sink according to claim 3, wherein the shunt resistor is arranged in the current path at the lower supply pole as the first element.

5. The current sink according to claim 1, wherein the measuring resistor is formed by one component measuring resistor per load path, each of the component measuring resistors being at least a portion of the respective load resistor.

6. The current sink according to claim 1, wherein the switch within at least one of the load paths is arranged nearest the lower supply pole as the first element of the series connection.

7. The current sink according to claim 1, wherein the connection for the LED chain is arranged in the current path at the upper supply pole as the first element of the series connection.

8. The current sink according to claim 1, wherein each of the switches is a PWM switch for a PWM mode of the LED chain.

9. A light source for a light device of an aircraft, having the current sink according to Claim 1, and having the LED chain comprising a plurality of LEDs connected in series, which is connected to the connection.

10. A light device for an aircraft, having at least one light source according to claim 9.

11. The light device according to claim 10, wherein the light device contains a supply module for supplying the supply poles of at least one of the light sources with a respective continuous DC voltage (Uga-c).

12. The light device according to claim 11, wherein the supply module is configured to select or change the magnitude of the continuous DC voltage (UGa-c) for at least one of the light sources on the basis of the magnitude of the element voltage (UE) dropped across the resistor element in the respective light source.

13. A method for producing a light source according to claim 9, comprising:
providing the LED chain,
selecting at least one of the load resistors according to an electrical property of the LED chain, and providing the current sink comprising these load resistors, and
connecting the provided LED chain to the connection of the provided current sink.

14. The method according to claim 13, wherein
a selection of at least two sets of load resistors is provided, each of the sets being at least a portion of the load resistors of at least one of the current sinks, and
at least one of the load resistors is selected by selecting one of the sets for the current sink and fitting the current sink with this set.
